(19) United States
(12) Patent Application Publication
(10) Pub. No.: US 2006/0255078 A1
(43) Pub. Date: Nov. 16, 2006

(54) Push-button spice dispensing cap

(75) Inventors: YoungJin Seo, Fresh Meadows, NY (US); Jeremy Brotchner, Forest Hills, NY (US)

Correspondence Address: TROUTMAN SANDERS LLP, 600 PEACHTREE STREET , NE, ATLANTA, GA, 30308, US

(73) Assignee: Lifetime Brands, Inc., Westbury, NY (US)

(21) Appl. No.: 11/432,645

(22) Filed: May 11, 2006

Related U.S. Application Data
(60) Provisional application No. 60/680,098, filed on May 12, 2005.

(51) Int. Cl. B67D 3/00

(52) U.S. Cl. 222/514

(57) ABSTRACT

A dispensing device for dispensing the contents of a container. The dispensing device for the container comprises a housing adapted to engage the container, a bias system containable within the housing, a cap capable of being extended outside the housing by the bias system, a restraint system for maintaining the cap in an open and closed position, and a guide system for preventing rotational movement by the restraint system. The contents can be dispensed from the inside to the outside of the container when the cap is in the open position, but not the closed position. By applying temporary downward pressure onto the top of the cap, the cap can be moved between the open and closed position. The push-button dispensing device, therefore, can be opened and closed using only one hand.

### CROSS REFERENCE TO RELATED APPLICATION

This application claims priority of U.S. Provisional Patent Application No. 60/680,098, filed 12 May 2005, the entire contents of which is hereby incorporated by reference.

### BACKGROUND

1. Field of the Invention

The present invention generally relates to a dispensing device for a container, and, in particular, to a push-button dispensing cap for a spice container that can be manipulated with one hand.

2. Description of Related Art

Dispensing containers are used in a variety of industries, for many different purposes. Generally, dispensing containers contain specific contents, such as liquids or particulates, which can be dispensed by an individual when desired. To prevent the contents of the container from being dispensed accidentally, many dispensing containers include a cap or lid that remains on the container during periods of nonuse.

In the food industry, dispensing containers are commonly used to contain solid foods, such as herbs or spices, in granular or powder-like form. Dispensing containers are often bountiful in the kitchen, containing such materials as salt, pepper, basil, cinnamon, dill, mustard powder, garlic salt or powder, ginger, thyme, rosemary, nutmeg, oregano, paprika, parsley, saffron, and turmeric, just to name a few. Such materials are key ingredients in a variety of recipes for various foods dishes.

In the culinary arts, a busy kitchen can be the focal point of creation, disarray, and demanding conditions. Amateur and professional chefs are often required to multitask during the cooking and/or creation process. For example, a cook may be stirring a substance with one hand, while adding additional ingredients with the other hand. Additionally, only one clean hand may be available for handling dispensing containers and utensils, because the other hand has been handling or preparing the food ingredients.

Typical dispensing containers, however, require the use of two hands for removing the cap or lid of the dispensing container, and for putting the cap or lid back on the dispensing container after use. Cooks are often left with the dilemma of either taking the chance of opening the dispensing container with dirty hands, or halting the food preparation process to wash or wipe their hands before handling the dispensing container. Further, when a cook opens the dispensing container with dirty hands, the process often involves an awkward handling of the dispensing container in an attempt to prevent the dispensing container from getting dirty.

What is needed is a push-button dispensing cap for a container that can be opened and closed easily with the use of only one hand, while adequately enabling the dispensing of contents in the open position, and securing the contents within the container in the closed position. It is to such a device that the present invention is primarily directed.

### BRIEF SUMMARY OF THE INVENTION

Briefly described, in preferred form, the present invention is a dispensing device for dispensing the contents of a container. The dispensing device includes a cap having an open position and a closed position, an opening system for moving the cap from the closed position to the open position, and a restraint system to limit the movement of the cap only between the open position and the closed position. In the open position, the contents can be dispensed from the inside to the outside of the container, but, in the closed position, the contents cannot be dispensed to the outside of the container.

The opening system can comprise a bias system that biases the cap to the open position and a triggering mechanism adapted to activate the bias system, when the cap is in the closed position. Accordingly, the triggering mechanism activates the bias system to move the cap from the closed position to the open position so that the contents of the container can be dispensed.

The dispensing device can further comprise a guide system adapted to provide guided travel of the cap, thereby ensuring that the restraint system is properly aligned to adequately maintain the cap in the open and closed positions. In a preferred embodiment, the guide system prevents rotational movement, limiting the cap to only an up and down line of travel.

Although the present invention described above refers to systems, the physical elements of the present invention include a housing adapted to engage the container, a bias body containable within the housing, a spring containable within the bias body, a cap capable of being extended outside the housing by the spring, a flexible engaging arm for maintaining the cap in an open and closed position, and a sealing washer adapted to seal the housing with the container. Further, the cap is formed to define one or more apertures for dispensing the contents of the container.

The flexible engaging arm is in communication with an upper portion of the bias body and engages with a lower restraint member when the cap is in the closed position, but engages with an upper restraint member when the cap is in the open position. Generally, the lower restraint member and upper restraint member are in communication with a lower portion of the bias body.

The present invention further comprises a stabilizing element, a groove to slideably receive the stabilizing element, and a guide restraint element that guides the flexible engaging arm and the cap between the open and closed positions. The stabilizing element and guide restraint element are in communication with the upper portion of the bias body, while the groove is in communication with the lower portion of the bias body.

In operation, beginning with the cap in the open position, the flexible engaging arm engages the upper restraint member, thereby preventing the spring from moving the cap beyond a predetermined distance above the housing. If a downward, closing force is applied to the top of the cap, the flexible engaging arm will disengage from the upper restraint member. If the cap is moved a predetermined distance, the flexible engaging arm will engage with the lower restraint member after the downward force dissipates. Accordingly, the cap will be in the closed position, with the spring in a compressed, energized state. The present invention is designed such that the cap will remain in the closed position unless the opening system is activated, thus inhibiting any accidental spills.

If another downward, triggering force is applied to the top of the cap, the flexible engaging arm will disengage with the lower restraint member. The upper restraint member produces an outward force to the flexible engaging arm, causing the end of the flexible engaging arm to move substantially outward and away from the lower restraint member. As the downward force dissipates, the end of the flexible engaging arm begins to move inwardly, while the spring biases the flexible engaging arm and the cap upwardly. The flexible engaging arm then engages with the upper restraint member, resulting in the cap being in the open position, with the spring in an uncompressed, non-energized state. The present invention is designed such that the cap will remain in the open position unless the downward, closing force is once again applied.

A principle object of the present invention is to provide a dispensing device that can be moved between an open and closed position with only one hand activation.

Another object of the present invention is to provide a dispensing device that allows the contents of a container to be dispensed outside the container when the dispensing device is in the open position, but not the closed position.

Still another object of the present invention is to provide a dispensing device that can be moved between the open position and the closed position by pressing the top of the dispensing device, preferably, by using only one hand.

It is another object of the present invention to provide a cap defining one or more apertures adapted to allow the contents of the container to be dispensed when the cap is in the open position, but not the closed position.

Yet another object of the present invention is to provide a bias system adapted to move the cap from the closed position to the open position.

Another object of the present invention is to provide a restraint system adapted to maintain the cap in the open or closed position.

Still another object of the present invention is to provide a guide system adapted to prevent rotational movement of the restraint system and, thereby, maintain a predetermined vertical alignment of the restraint system.

It is another object of the invention is to provide a housing to contain the cap, the bias system, the restraint system, and the guide system.

These and other objects, features and advantages of the present invention will become more apparent upon reading the following specification in conjunction with the accompanying drawings.

### BRIEF DESCRIPTION OF THE FIGURES

FIG. 1 illustrates a perspective view of a dispensing cap for a container in accordance with preferred embodiments of the present invention.

FIGS. 2A-2C, collectively known as FIG. 2, illustrate perspective and sectional views of a cap in accordance with preferred embodiments of the present invention.

FIGS. 3A-3C, collectively known as FIG. 3, illustrate perspective and sectional views of a housing in accordance with preferred embodiments of the present invention.

FIGS. 4A-4E, collectively known as FIG. 4, illustrate perspective and sectional views of a restraining system in a first and second position in accordance with preferred embodiments of the present invention.

FIG. 5 illustrates a perspective view of a bias system in accordance with preferred embodiments of the present invention.

FIGS. 6A-6B, collectively known as FIG. 6, illustrate perspective views of a guide system in accordance with preferred embodiments of the present invention.

### DETAILED DESCRIPTION OF THE PREFERRED EMBODIMENTS

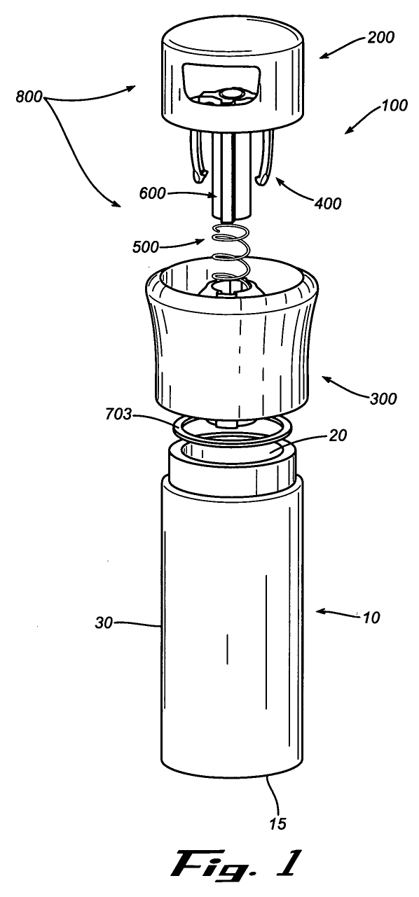

Referring now in detail to the drawing figures, wherein like reference numerals represent like parts throughout the several views, a dispensing device 100 of FIG. 1 utilizes a container 10, typically a cylindrical glass spice container. The dispensing device 100 is designed for allowing contents within the container 10, such as herbs or spices, to be dispensed from the inside of the container 10 to the outside of the container 10 when the dispensing device 100 is in an open position, but prevents contents within the container 10 from being dispensed to the outside of the container 10 when the dispensing device 100 is in a closed position. The dispensing device 100 can be configured for containers 10 of varying sizes and shapes. Generally, the dispensing device 100 is configured for a spice container 10 having an upper open end 20, a bottom 15, and a peripheral wall 30 extending upwardly from the bottom 15 to the upper open end 20.

As shown in FIG. 1, the dispensing device 100 comprises a cap 200, an opening system 800, and a restraint system 400. The opening system 800 comprises a triggering mechanism and a bias system 500 and is adapted to move the cap 200 of the dispensing device 100 from the closed position to the open position. The restraint system 400 maintains the cap 200 of the dispensing device 100 in the open or closed position. When activated, the triggering mechanism permits the opening system 800 to move the cap 200 of the dispensing device 100 from the closed position to the open position.

The triggering mechanism of the opening system 800 comprises the interplay between the cap 200, the bias system 500, and the restraint system 400. The triggering mechanism is activated by applying a downward, triggering force to the top of the cap 200. As the cap 200 is moved slightly downward, the restraint system 400 temporarily disengages so that the bias system 500 can move the cap 200 from the closed position to the open position. Then, the restraint system 400 reengages to maintain the cap 200 in the open position.

The dispensing device 100 can further comprise a guide system 600, such that the guide system 600 is adapted to guide the cap 200 and restraint system 400 between the closed position and the open position. Typically, the guide system 600 prevents rotational movement of the cap 200 of the dispensing device 100 when moving between the open position and the closed position, or when the cap 200 of the dispensing device 100 is restrained by the restraint system 400.

In a preferred embodiment of the present invention, the cap 200 is formed to define one or more dispensing apertures 230. The dispensing aperture 230 is in communication with the inside of the container 10, but not the outside of the container 10, when the cap 200 is in the closed position. Accordingly, the contents of the container 10 cannot be dispensed outside the container 10 when the cap 200 is in the closed position. The dispensing aperture 230 is in communication with the inside and outside of the container 10 when the cap 200 is in the open position. When in the open position, the contents of the container 10 can be dispensed from the inside of the container 10 to the outside of the container 10.

More specifically, the dispensing device 100 comprises a cap 200, a housing 300, a restraint system 400, and a bias system 500. The container 10 interfaces with the housing 300 of the dispensing device. The housing 300 has a lower open end 305 adapted to engage the upper open end 20 of the container 10. The bias system 500 is containable within the housing 300, such that the bias system 500 is positioned generally vertical within the housing 300.

The cap 200 is adapted to allow the contents within the container 10 to be dispensed to the outside of the container 10. In other words, the cap 200 can provide a passage or channel between the inside of the container 10 and the outside of the container 10, so that the contents of the container 10 can be easily removed or dispensed from within the container 10. Further, the cap 200 can be extended outside of the housing 300 by the bias system 500. The bias system 500 generally biases the cap 200 towards the outside of the housing 300, while the restraint system 400 is adapted to maintain the cap 200 in a first position (also referred to herein as the closed position), within the housing 300, and a second position (also referred to herein as the open position), extending outside the housing 300.

As mentioned above, the dispensing device 100 can further comprise a guide system 600. The guide system 600 is containable within the housing 300 and, more particularly, is adapted to guide the restraint system 400 between the closed position and the open position. Further, the dispensing device 100 comprises a sealing member 703, such that the sealing member 703 is adapted to seal the lower open end 305 of the housing 300 with the upper open end 20 of the container 10. One skilled in the art will recognize that the sealing element 703 can include, but is not limited to, a washer, a gasket, o-ring, extrusion, or other appropriate sealing element 703. Within a preferred embodiment of the present invention, the sealing element 703 is a plastic washer having an inner diameter and outer diameter substantially equal to the inner diameter and outer diameter of the upper open end 20 of the container 10.

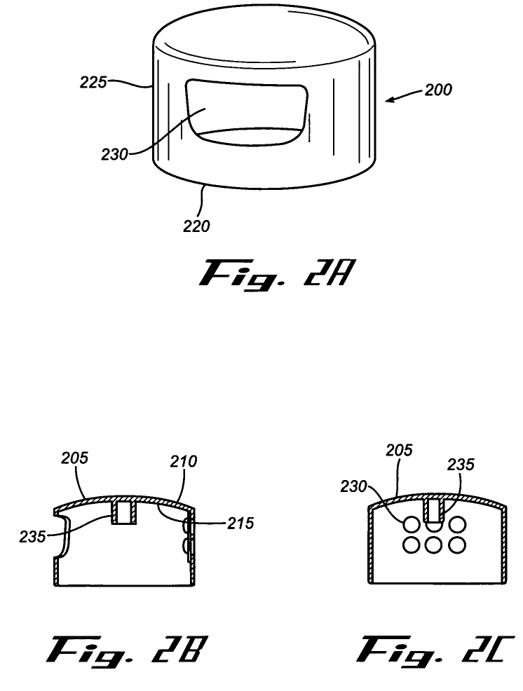

As illustrated in FIGS. 2A-2C, the cap 200 comprises a top 205, a lower open end 220, and a peripheral side wall 225 defining one or more dispensing apertures 230. The top 205 of the cap 200 has an upper side 210 and a lower side 215, such that the upper side 210 is in communication with the outside of the container 10 and the lower side 215 is in communication with the inside of the container 10. The peripheral side wall 225 typically extends downwardly from the top 205 of the cap 200 to the lower open end 220 of the cap 200.

When the cap 200 is in the open position, the dispensing aperture 230 is in communication with the inside and outside of the container 10, thereby allowing the contents of the container 10 to be removed or dispensed from the container 10. When the cap 200 is in the closed position, the dispensing aperture 230 is in communication with the inside of the container 10, but is not in communication with the outside of the container 10. Accordingly, contents of the container 10 cannot be removed or dispensed from the container 10 when the cap 200 is in the closed position.

Preferably, the cap 200 has one large dispensing aperture 230 defined by the peripheral side wall 225 and located on a fist side of the cap 200, while a plurality of six smaller dispensing apertures 230 defined by the peripheral side wall 225 are located on an opposite side of the cap 200. One skilled in the art will recognize that the one large dispensing aperture 230 permits a substantial amount of contents to be dispensed from the container 10 in a short period of time, while the plurality of six smaller dispensing apertures 230 permits a smaller amount of contents to be dispensed from the container 10 in the same period of time. As illustrated in FIG. 2C, the plurality of six smaller dispensing apertures 230 can be arranged in two rows of three, whereby a first row of three smaller dispensing apertures 230 is positioned above a second row of three smaller dispensing apertures 230. One skilled in the art, however, will recognize that the dispensing apertures 230 can be arranged in a variety of configuration without departing from the scope of the present invention.

The cap 200 further comprises a coupling member 235, such that the coupling member 235 is in communication with the lower side 215 of the top 205 of the cap 200. The coupling member 235 is adapted to engage the bias system 500 and, in another embodiment, the restraint system 400. As described more fully below, the bias system 500 can be contained with the housing 300, while also being attached to the coupling member 235 of the cap 200.

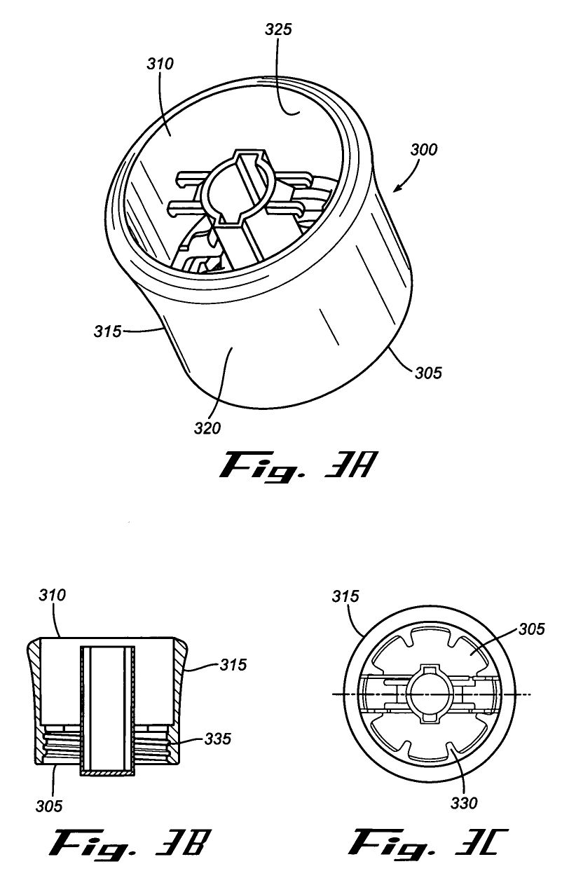

The housing 300, as illustrated in FIGS. 3A-3C, comprises a lower open end 305, an upper open end 310, a peripheral side wall 315 having an outer side 320 and an inner side 325, and a plurality of stopping members 330. As described above, the lower open end 305 of the housing 300 is adapted to engage the upper open end 20 of the container 10. One skilled in the art will recognize that the lower open end 305 of the housing 300 can be attached to the upper open end 20 of the container 10 in a variety of ways including, but not limited to, an adhesive such as paste, glue, tape, or bond; a bolt, screw, peg, or pin; a clamp; a fastener; a clip; a rivet; a hinge; a coupling; a weld; or other appropriate attachment.

Preferably, a helical thread 335 is in communication with the inner side 325 of the peripheral side wall 315 of the housing 300, such that the helical thread 335 is positioned near the lower open end 205 of the housing 300. Likewise, the outer side of the upper open end 20 of the container 10 comprises a similar thread, so that the housing 300 can easily be screwed on and off of the container 10.

The upper open end 310 of the housing 300 is adapted to slideably receive the lower open end of the cap 200. Accordingly, the cap 200 can slide into the housing 300 when moved to the closed position, and can slide partially out of the housing 300 (e.g., extend from the housing 300) when moved to the open position.

The peripheral side wall 315 extends downwardly from the upper open end 310 of the housing 300 to the lower open end 305 of the housing 300. Positioned near the lower open end 305 of the housing 300, the plurality of stopping members 330 are in communication with the inner side 325 of the peripheral side wall 315, such that the plurality of stopping members 330 are adapted to prevent the upper open end 20 of the container 10 from reaching a predetermined level within the housing 300 (e.g., preventing the housing 300 from being screwed too far onto the container 10). In an embodiment of the present invention, the plurality of stopping members 330 include small plastic tabs evenly spaced around the perimeter of the inner side 325 of the peripheral side wall 315. More specifically, the stopping members 330 are positioned just above the helical thread 335 located near the lower open end 305 of the housing 300. As the housing 300 is screwed onto the container 10, the stopping members 330 engage the upper open end 20 of the container 10 to prevent the upper open end 20 of the container 10 from reaching a predetermined level within the housing 300.

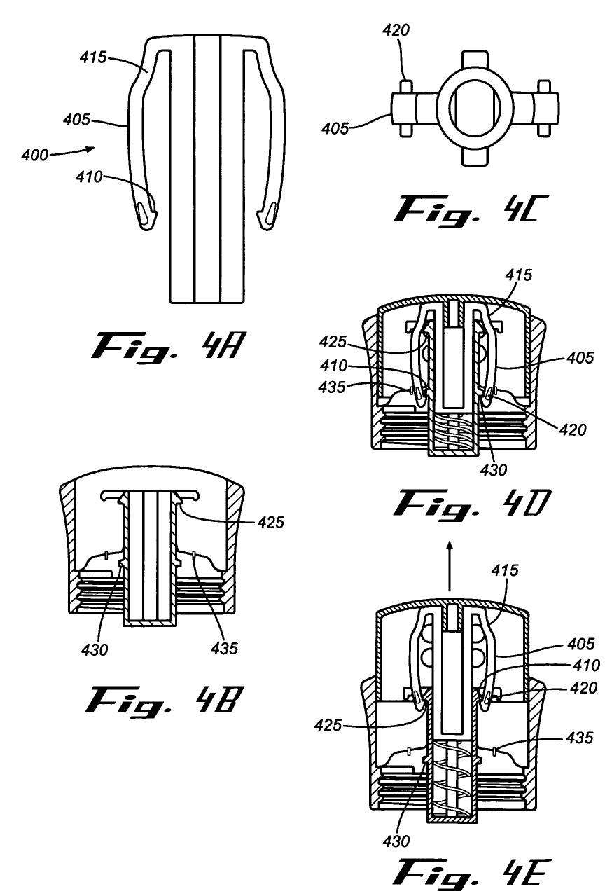

As illustrated in FIGS. 4A-4E, the restraint system 400 comprises one or more flexible engaging members 405, one or more upper restraint members 425, and one or more lower restraint members 430. The flexible engaging member 405 includes a projection member 410 at a proximal first end of the flexible engaging member 405 and a tapered upper portion 415 at a distal second end of the flexible engaging member 405. Preferably, the flexible engaging member 405 is a flexible plastic arm extending downwardly from the distal second end.

The projection member 410 of the flexible engaging member 405 engages an upper restraint member 425 when the cap 200 is in the open position. Similarly, the projection member 410 of the flexible engaging member 405 engages a lower restraint member 430 when the cap 200 is in the closed position.

The tapered upper portion 415 of the flexible engaging member 405 is generally in communication with an upper portion 510 of the bias system 500, while the upper restraint member 425 and the lower restraint member 430 are generally in communication with a lower portion 520 of the bias system 500. The upper portion 510 of the bias system 500 is in communication with the coupling member 235 of the cap 200 and the lower portion 520 of the bias system is contained within the housing 300. Accordingly, the upper portion 510 of the bias system 500 and the flexible engaging member 405 of the restraint system 400 move simultaneously with the cap 200 between the open position and the closed position.

The lower restraint member 430 maintains the flexible engaging member 405 and, therefore, the cap 200 in the closed position, although the bias system 500 is biased to moving the cap 200 towards the open position. The upper restraint member 425 maintains the flexible engaging member 405 and, therefore, the cap 200 in the open position, although the bias system 500 is biased to moving the cap 200 further from the housing 300.

The restraint system 400 further comprises one or more restraint tab members 420 and one or more block members 435. The restraint tab member 420 is typically in communication with the proximal first end of the flexible engaging member 405, such that the restraint tab member 420 is generally perpendicular with the projection member 410. The block member 435 can be positioned a predetermined distance from the lower restraint member 430. In an embodiment of the present invention, the block member 435 is horizontally aligned with the lower restraint member 430.

Typically, the cap 200 is moved from the open position to the closed position by applying a downward, closing force to the top 205 of the cap 300, until the flexible engaging member 405 disengages with the upper restraint member 425 and then engages the lower restraint member 430. When the cap 200 is in the closed position, the projection member 410 of the flexible engaging member 405 is restrained by the lower restraint member 430, as illustrated in FIG. 4D. As another downward, triggering force is applied to the top 205 of the cap 200, the restraint system 400 is slightly moved further down into the housing 300. The upper restraint member 425 is further adapted to apply an outward force to the tapered upper portion 415 of the flexible engaging member 405 during the application of the downward force. The outward force applied by the upper restraint member 425 causes the proximal first end of the flexible engaging member 405 to move substantially outward. Accordingly, the projection member 410 of the flexible engaging member 405 disengages with the lower restraint member 430.

As the downward, triggering force is removed, the bias system 500 attempts to move the cap 200 and, therefore, the restraint system 400 towards the open position. The block member 435 is adapted to permit the flexible engaging member 405 to move outward, but is adapted to temporarily engage the restraint tab member 420 of the flexible engaging member 405 as the proximal end of the flexible engaging member 405 attempts to move inward towards the lower restraint member 430. Such a temporary engagement prevents the projection member 410 of the flexible engagement member 405 from engaging with the lower restraint member 430 and, therefore, prevents the cap 200 from remaining in the closed position after a downward, triggering force has been applied. Accordingly, as the restraint system 400 is moved upward to the open position, the projection member 410 of the flexible engagement member 405 engages with the upper restraint member 425, as illustrated in FIG. 4E.

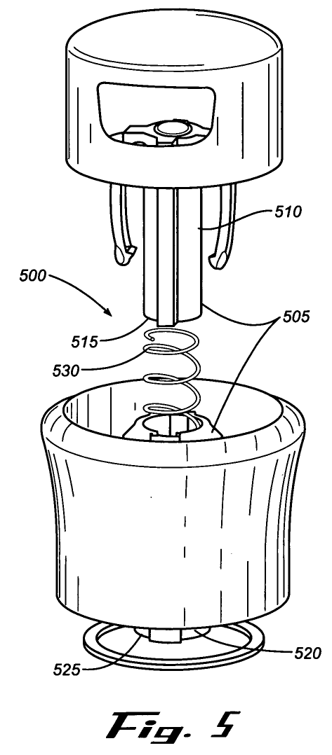

The bias system 500, as illustrated in FIG. 5, comprises a bias body 505 and a bias member 530. The bias member 530 is containable within the bias body 505, which includes an upper portion 510 and a lower portion 520, such that the upper portion 510 of the bias body 505 is slideably disposed within the lower portion 520 of the bias body 505.

The upper portion 510 of the bias body 505 has a first bias seat 515 that is adapted to interface with the top portion of the bias member 530. In an embodiment of the present invention, the first bias seat 515 is positioned at the lower end of the upper portion 510 of the bias body 505. Additionally, the lower portion 520 of the bias body 505 has a second bias seat 525 that is adapted to interface with the bottom portion of the bias member 530. In an embodiment of the present invention, the second bias seat 525 is positioned at the lower end of the lower portion 520 of the bias body 505.

When the cap 200 is in the closed position, the first bias seat 515 of the upper portion 510 of the bias body 505 has been lowered upon the top of the bias member 530. Accordingly, the bias member 530 is in a compressed, energized state, wherein the bias member 530 applies upward force to the first bias seat 515 attempting to move the upper portion 510 of the bias body 505 and, therefore, the cap 200 to the open position. When the cap 200 is in the open position, the bias member 530 is in an uncompressed, non-energized state, wherein the bias member 530 applies little or no upward force to the first bias seat 515 of the upper portion 510 of the bias body 505.

One skilled in the art will recognize that the bias member 530 can include, but is not limited to, a spring, a coil, a pressurized chamber, a flexible piece of metal, rubber, or plastic, or other appropriate device that is compressible, yet resilient. Preferably, the bias member 530 is a spring, with enough resilience to effectively move the cap 200, restraint system 400, and upper portion 510 of the bias body 505 between the open and closed positions.

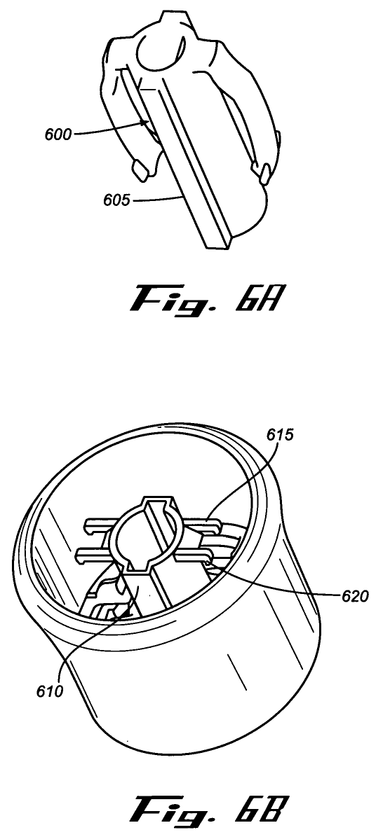

As illustrated in FIGS. 6A-6B, the guide system 600 comprises one or more stabilizing elements 605, one or more groove elements 610, and one or more guide restraint elements 615. Typically, the groove element 610 is adapted to slideably receive the stabilizing element 605. The guide restraint element 615 is adapted to guide the flexible engaging member 405 of the restraining system 400 between the open and closed positions. As discussed above, the guide system 600 prevents rotational movement of the cap 200 when moving between the open position and the closed position, and when the cap 200 is restrained by the restraint system 400.

Preferably, the stabilizing element 605 protrudes outwardly from the upper portion 510 of the bias body 505 and the groove element 610 is in communication with the lower portion 520 of the bias body 505. Accordingly, the communication between the stabilizing element 605 and the groove element 610 prevents rotational movement of the bias system 500, which in turn prevents rotational movement of the restraint system 400 and the cap 200, because the restraint system 400 and the cap 200 are connected to the bias system 500. The guide system 600, therefore, ensures that the projection member 410 of the flexible engaging member 405 remains vertically align with the upper restraint member 425 and the lower restraint member 430 of the restraint system 400.

The guide restraint element 615 is adapted to guide the flexible engaging member 405 of the restraint system 400 between the open position to the closed position. More specifically, the guide restraint element 615 also ensures that the projection member 410 of the flexible engaging member 405 remains vertically align with the upper restraint member 425 and the lower restraint member 430 of the restraint system 400.

Further, the guide restraint element 615 is adapted to engage the restraint tab member 420 of the flexible engaging member 405 when the restraint system 400 is in the open position. The guide restraint element 615 prevents the cap 200 and the restraint system 400 from extending beyond a predetermined distance from the housing 300. In other words, the guide restraint element 615 assists the upper restraint member 425 in preventing the cap 200 from disconnecting with the housing 300.

Additionally, the guide restraint element 615 comprises a guide block element 620. The guide block element 620 is generally positioned at an outward end of the guide restraint element 615, such that the guide block element 620 is adapted to prevent the flexible engaging member 405 from moving outwardly beyond a predetermined distance, when the cap 200 is in the open position. If the projection member 410 of the flexible engaging member 405 should ever disengage with the upper restraint member 425 of the restraint system 400 when no downward force is present, then the guide block element 620 will engage with the restraint tab member 420 of the flexible engaging member 405 to prevent the cap 200 from disconnecting with the housing 300.

One skilled in the art will recognize that the cap 200, housing 300, restraint system 400, bias system 500, guide system 600, and all of the components and/or elements thereof can be made of a variety of suitable materials including, but not limited to, plastic, rubber, metal, ceramic, or other suitable materials or a combination thereof.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A dispensing device for a container having an upper open end, the dispensing device comprising:
a cap defining at least one aperture for dispensing contents;
an opening system adapted to move the cap from a closed position to an open position, wherein the contents can only be dispensed when the cap is in the open position;
a triggering mechanism adapted to permit the cap to move from the closed position to the open position; and
a restraining system for maintaining the cap in the closed or open position.

2. The dispensing device of claim 1, wherein the open system comprises:
a housing for slideably receiving the cap; and
a bias member positioned within the housing, wherein the bias member is adapted to move the cap from the closed position to the open position when triggered by the triggering mechanism.

3. The dispensing device of claim 1 further comprising a guide system adapted to guide the cap between the closed position and the open position.

4. A dispensing device for a container, the dispensing device comprising:
a housing having a lower open end adapted to engage an upper open end of a container;
a cap defining at least one aperture for dispensing contents from the container, wherein the cap is slideably received within the housing;
a bias system containable within the housing, wherein the bias system is capable moving the cap from a closed position within the housing to an open position partially outside the housing; and
a restraint system adapted to maintain the cap in the open position when the cap is within the housing and the closed position when the cap is partially outside the housing.

5. The dispensing device of claim 4, the dispensing device further comprising a guide system containable within the housing, wherein the guide system is adapted to guide the restraint system between the open position and the closed position.

6. The dispensing device of claim 5, the dispensing device further comprising a sealing member adapted to seal the lower open end of the housing with the upper open end of the container.

7. The dispensing device of claim 4, wherein the at least one aperture is in communication with an inside and outside of the container when the cap is in the open position, thereby allowing the contents from inside the container to be dispensed outside the container.

8. The dispensing device of claim 7, wherein the at least on aperture of the cap is not in communication with the outside of the container when the cap is in the closed position, thereby preventing the contents from inside the container from being dispensed outside the container.

9. The dispensing device of claim 4, wherein the housing further comprises a plurality of stopping members in communication with an inner side of the housing, wherein the plurality of stopping members are adapted to prevent the upper open end of the container from reaching a predetermined level within the housing.

10. The dispensing device of claim 4, wherein the housing further comprises a helical thread in communication with the inner, lower side of the housing, wherein the helical thread permits the housing to be screwed onto an upper open end of the container.

11. The dispensing device of claim 4, wherein the bias system comprises:
a bias body having an upper portion slideably receivable within a lower portion, wherein the upper portion is positioned within the cap and the lower portion is positioned within the housing; and
a bias member containable within the bias body.

12. The dispensing device of claim 11, wherein the upper portion of the bias body includes a first bias seat and the lower portion of the bias body includes a second bias seat, wherein the first bias seat and the second bias seat are adapted to engage the bias member.

13. The dispensing device of claim 12, wherein the bias member is energized when the cap is in the closed position and non-energized when the cap is in the open position.

14. The dispensing device of claim 4, wherein the restraint system comprises:
at least one flexible engaging member having a projection member at a proximal first end and a tapered upper portion at a distal second end;
at least one lower restraint member, wherein the at least one lower restraint member engages the projection member of the at least one flexible engaging member when the cap is in the closed position; and
at least one upper restraint member, wherein the at least one upper restraint member engages the projection member of the at least one flexible engaging member when the cap is in the open position.

15. The dispensing device of claim 14, wherein the tapered upper portion of the at least one flexible engaging member is in communication with the upper portion of the bias body and wherein the at least one lower restraint member and the at least one upper restraint member are in communication with the lower portion of the bias body.

16. The dispensing device of claim 15, wherein the restraint system further comprises:
at least one restraint tab member in communication with the proximal first end of the at least one flexible engaging member; and
at least one block member positioned a predetermined distance from the at least one lower restraint member, wherein the at least one upper restraint member is further adapted to apply an outward force to the tapered upper portion of the at least one flexible engaging member when a downward force is applied to the top of the cap, the outward force causing the proximal first end of the at least one flexible engaging member to move substantially outward, and wherein the at least one block member is adapted to temporarily engage the at least one restraint tab member to prevent the projection member of the at least one flexible engaging member from engaging the at least one lower restraint member when the bias system moves the cap towards the open position.

17. The dispensing device of claim 16, wherein the guide system comprises:
at least one stabilizing element extending outwardly from the upper portion of the bias body;
at least one groove element adapted to slideably receive the at least one stabilizing element, wherein the at least one groove element is positioned on the lower portion of the bias body; and
at least one guide restraint element, wherein the at least one guide restraint element is adapted to guide the flexible engaging member from the closed position and the open position.

18. The dispensing device of claim 17, wherein the at least one guide restraint element is further adapted to engage the at least one restraint tab member of the flexible engaging member when the cap is in the closed position, thereby preventing the cap from extending beyond a predetermined distance from the housing.

19. The dispensing device of claim 18, wherein the at least one guide restraint comprises a guide block element adapted to prevent the flexible engaging member from moving outwardly beyond a predetermined distance when the cap is in the closed position.

20. A dispensing device for a container, the dispensing device comprising:
a housing having a lower open end adapted to engage an upper open end of a container;
a cap defining at least one aperture for dispensing contents from the container, wherein the cap is slideably received within the housing;
a bias body having an upper portion and a lower portion, wherein the upper portion is contained within the cap and the lower portion is contained within the housing;
a bias member received within the bias body, wherein the bias member is adapted to move the cap from a closed position to an open position;
at least one flexible engaging member having a projection member at a proximal first end and a tapered upper portion at a distal second end;
at least one lower restraint member located at a first position on the lower portion of the bias body, wherein the at least one lower restraint member engages the projection member of the at least one flexible engaging member when the cap is in the closed position; and
at least one upper restraint member located at a second position on the lower portion of the bias body, wherein the at least one upper restraint member engages the projection member of the at least one flexible engaging member when the cap is in the open position.
